(19) United States
(12) Patent Application Publication
(10) Pub. No.: US 2014/0368059 A1
(43) Pub. Date: Dec. 18, 2014

(54) TRANSFORMER, ELECTRONIC APPARATUS, AND METHOD FOR CONTROLLING TRANSFORMER

(71) Applicant: FUJITSU LIMITED, Kawasaki-shi (JP)

(72) Inventors: Takahiko SUGAWARA, Kawasaki (JP); Hiroshi Nakao, Yamato (JP)

(73) Assignee: FUJITSU LIMITED, Kawasaki-shi (JP)

(21) Appl. No.: 14/280,806

(22) Filed: May 19, 2014

(30) Foreign Application Priority Data
Jun. 17, 2013 (JP) 2013-126527

(51) Int. Cl. H01F 27/08; H01F 27/40

(52) U.S. Cl. CPC H01F 27/085; H01F 27/402; H01F 2027/406
USPC 307/117; 336/61

(57) ABSTRACT

A transformer includes a core, a coil wound around the core, and a heat sink coupled to the coil. An electronic apparatus includes: a transformer that includes a core, a coil wound around the core, and a heat sink coupled to the coil; a temperature sensor that measures a temperature of the heat sink; and a controller that controls power to be supplied to the coil based on the temperature measured by the temperature sensor.

### CROSS-REFERENCE TO RELATED APPLICATION

This application is based upon and claims the benefit of priority of the prior Japanese Patent Application No. 2013-126527, filed on Jun. 17, 2013, the entire contents of which are incorporated herein by reference.

### FIELD

The embodiments discussed herein are related to transformers, electronic apparatuses, and methods for controlling a transformer.

### BACKGROUND

In the past, a coil unit such as a transformer, an inductor, or the like has been used. For example, a coil unit such as a transformer is used by being incorporated into a power source circuit of an electronic device.

With miniaturization of the electronic device, an attempt to make a coil unit that is incorporated into the electronic device smaller has been made.

The coil unit is formed as a core made of a magnetic material, the core around which a coil is wound. The coil unit generates heat as a result of a current flowing through the coil, and, with miniaturization of the coil unit, the amount of heat generation per unit volume increases.

Moreover, as a power source increases in capacity due to an improvement in performance of the electronic device into which the coil unit is incorporated, the current flowing through the coil of the coil unit incorporated into the power source increases. As a result, the amount of heat generation per unit volume of the coil unit increases.

For example, an increase in temperature worsens the transformation characteristics of the transformer.

As a method for dissipating the heat generated in the coil of the transformer, there is a natural air cooling method using natural air convection, a forced air cooling method that forcedly sends air by using a fan, or the like.

The following are reference documents.
[Document 1] Japanese Laid-open Patent Publication No. 2000-77239 and
[Document 2] Japanese Laid-open Patent Publication No. 6-249745.

### SUMMARY

According to an aspect of the invention, a transformer includes a core, a coil wound around the core, and a heat sink coupled to the coil.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view depicting a first embodiment of a coil unit disclosed in the present specification;

FIG. 2 is a front view depicting the first embodiment of the coil unit disclosed in the present specification;

FIG. 3 is a plan view depicting the first embodiment of the coil unit disclosed in the present specification;

FIG. 4 is a side view depicting the first embodiment of the coil unit disclosed in the present specification;

FIG. 5 is a sectional view taken on the line V-V of FIG. 1;

FIG. 6 is a diagram depicting the calculation results of the temperature of the coil unit;

FIG. 7 is a perspective view depicting a coil unit of a comparative example;

FIG. 8 is a perspective view depicting a second embodiment of the coil unit disclosed in the present specification;

FIG. 9 is a side view depicting the second embodiment of the coil unit disclosed in the present specification;

FIG. 10 is a diagram of the relationship between the magnetic field strength and the distance from the center of a cover;

FIG. 11 is a side view depicting a third embodiment of the coil unit disclosed in the present specification;

FIG. 12 is a sectional view of a heat sink of the coil unit;

FIG. 13 is a perspective view depicting a fourth embodiment of the coil unit disclosed in the present specification;

FIG. 14 is a sectional view taken on the line XIV-XIV of FIG. 13;

FIG. 15 is a side view depicting a fifth embodiment of the coil unit disclosed in the present specification;

FIG. 16 is a plan view depicting the fifth embodiment of the coil unit disclosed in the present specification; and

FIG. 17 is a diagram depicting an electronic apparatus provided with the coil unit disclosed in the present specification.

### DESCRIPTION OF EMBODIMENTS

Hereinafter, a preferred first embodiment of a coil unit disclosed in the present specification will be described with reference to the drawings. However, the technical scope of the present specification is not limited to the embodiments and covers the scope of the claims and the equivalents thereof.

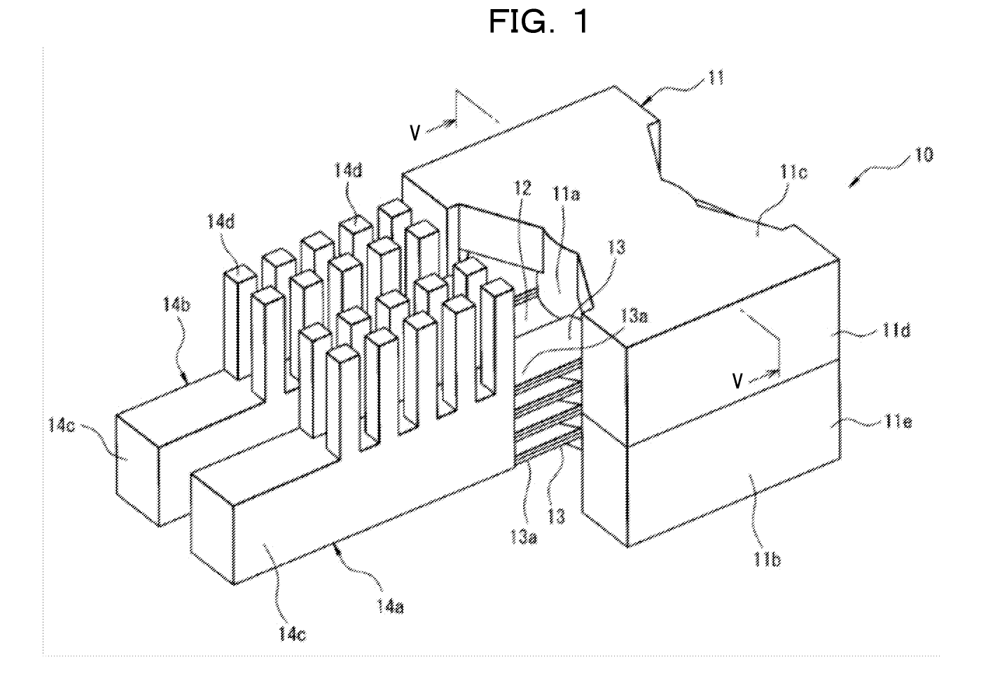

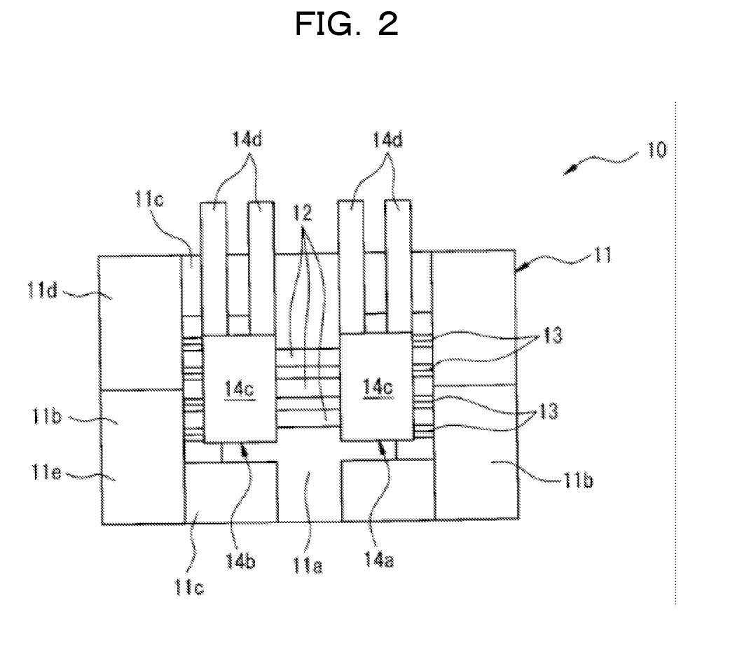

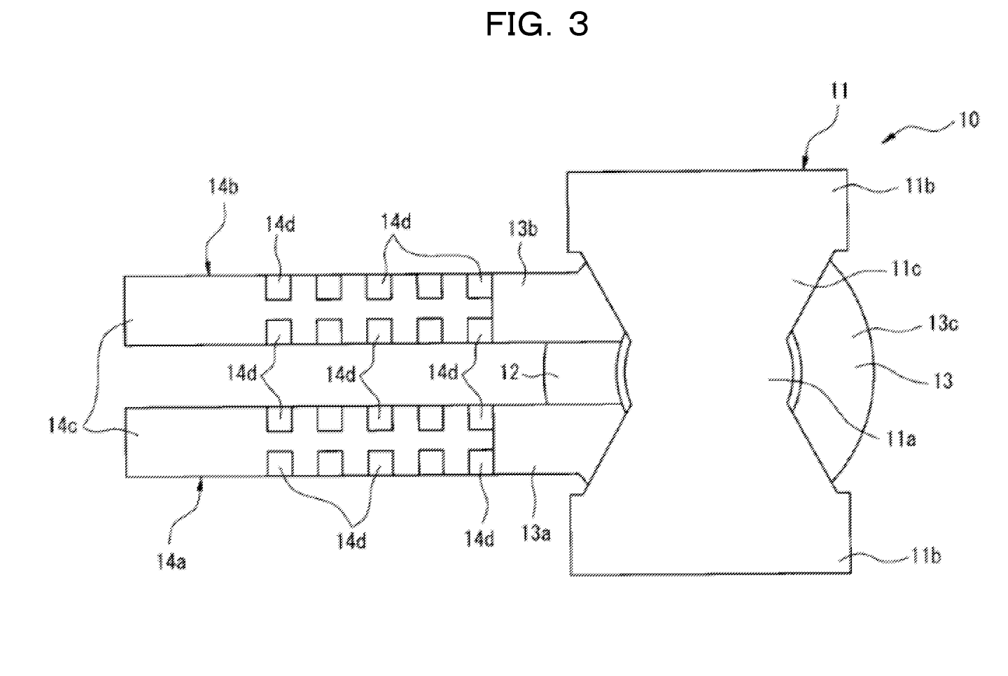

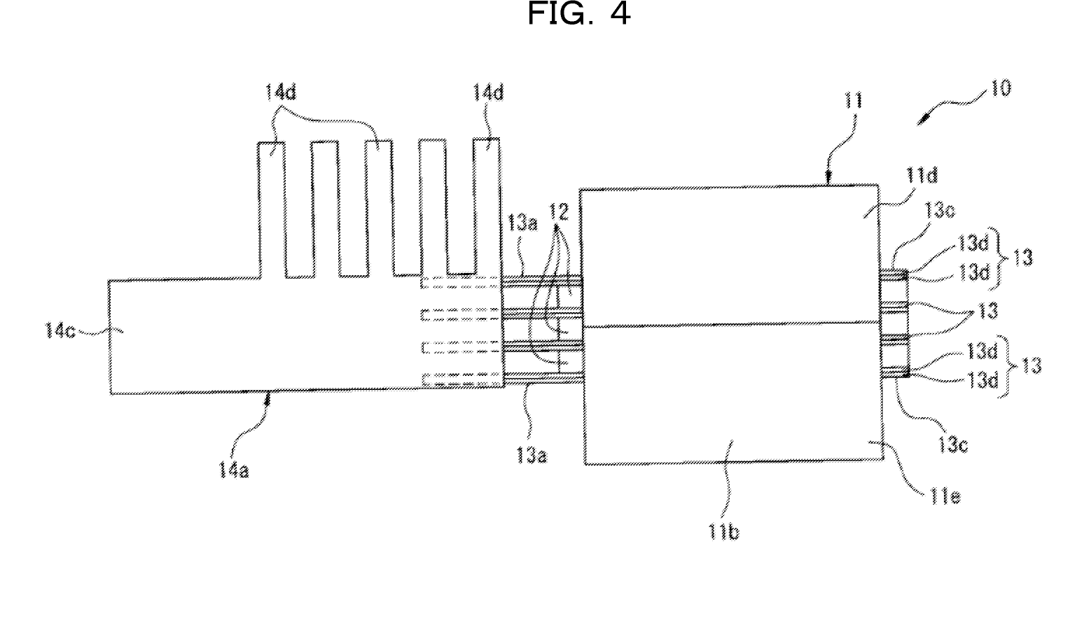

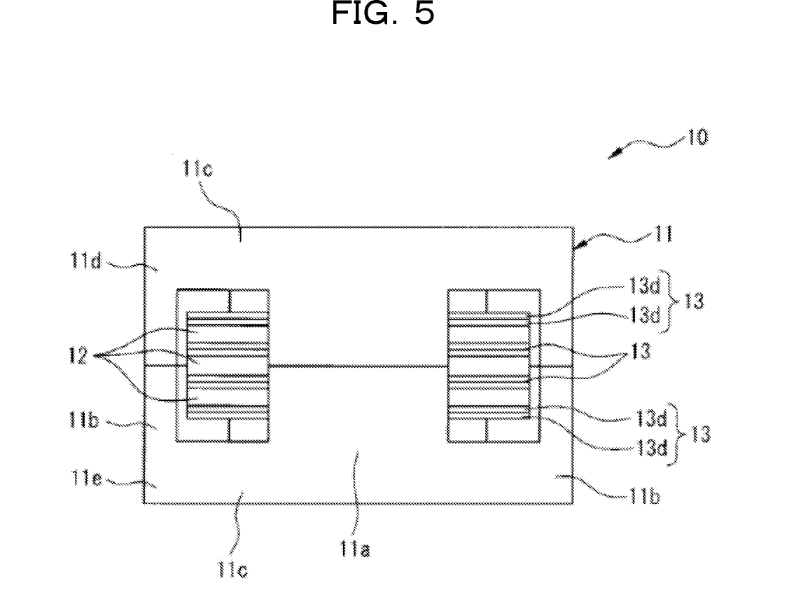

FIG. 1 is a perspective view depicting the first embodiment of the coil unit disclosed in the present specification. FIG. 2 is a front view depicting the first embodiment of the coil unit disclosed in the present specification. FIG. 3 is a plan view depicting the first embodiment of the coil unit disclosed in the present specification. FIG. 4 is a side view depicting the first embodiment of the coil unit disclosed in the present specification. FIG. 5 is a sectional view taken on the line V-V of FIG. 1.

A coil unit 10 of this embodiment includes a core 11, a primary-side coil 12 and a secondary-side coil 13 which are wound around the core 11, and heat sinks 14a and 14b that connect to ends 13a and 13b of the secondary-side coil 13.

The core 11 has an inner magnetic leg 11a around which the primary-side coil 12 and the secondary-side coil 13 are wound and a pair of outer magnetic legs lib disposed in such a way as to sandwich the inner magnetic leg 11a around which the coils 12 and 13 are wound.

Moreover, the core 11 has a pair of side magnetic sections 11c that connects the inner magnetic leg 11a and the pair of outer magnetic legs 11b in such a way as to form a magnetic circuit.

In the coil unit 10, the core 11 is formed by joining a core half body 11d formed of upper parts of the longitudinally-halved inner magnetic leg 11a, the longitudinally-halved pair of outer magnetic legs 11b, and the longitudinally-halved pair of side magnetic sections 11c and a core half body 11e formed of lower parts of the longitudinally-halved inner magnetic leg 11a, the longitudinally-halved pair of outer magnetic legs 11b, and the longitudinally-halved pair of side magnetic sections 11c.

The core 11 is formed of a magnetic material. Specifically, it is possible to form the core 11 by using Mn—Zn ferrite, Ni—Zn ferrite, a dust core, or the like.

The coil unit 10 is a so-called PQ-type transformer, and part of the primary-side coil 12 and the secondary-side coil 13 is exposed to the outside from the opening of the core 11.

In the coil unit 10, the number of times of winding of the primary-side coil 12 is greater than the number of times of winding of the secondary-side coil 13, and the coil unit 10 is a step-down transformer that steps down the voltage applied to the primary-side coil 12 and derives the voltage from the secondary-side coil 13.

The primary-side coil 12 is formed as a result of one conductor line coated with an insulating film (not depicted) having electrical insulating properties being wound around the inner magnetic leg 11a. The ends (not depicted) of the primary-side coil 12 are drawn to the outside through the opening of the core 11.

It is possible to form the secondary-side coil 13 by stacking two conductive plates 13d having the shape of a horseshoe. The part of the secondary-side coil 13 wound around the inner magnetic leg 11a is coated with an insulating film (not depicted) having electrical insulating properties.

The secondary-side coil 13 has a winding section 13c wound around the inner magnetic leg 11a and the ends 13a and 13b extending from the ends of the winding section 13c toward the outside of the core 11. In the coil unit 10, the winding section 13c is not wound around the inner magnetic leg 11a in such a way as to go round the inner magnetic leg 11a, but, in the present specification, winding includes being wound around the inner magnetic leg 11a in a manner like the winding section 13c of the secondary-side coil 13.

The coil unit 10 includes four secondary-side coils 13 disposed at intervals. Between the secondary-side coils 13, part of the primary-side coil 12 is disposed. Incidentally, the number of secondary-side coils 13 may be smaller than four or greater than four.

As the formation material of the primary-side coil 12 or the secondary-side coil 13, it is possible to use, for example, copper, gold, silver, carbon, or the like.

In the coil unit 10 which is a step-down transformer, since a larger amount of current flows through the secondary-side coils 13 than the primary-side coil 12 in accordance with the turns ratio, the amount of heat generation of the secondary-side coils 13 is larger than the amount of heat generation of the primary-side coil 12.

Thus, in the coil unit 10, by connecting the heat sinks 14a and 14b which are separate bodies to the secondary-side coils 13 and transferring the heat generated in the secondary-side coils 13 to the heat sinks 14a and 14b and dissipating the heat from the heat sinks 14a and 14b, an increase in the temperature of the coil unit 10 is suppressed.

The heat sink 14a possesses not only thermal conductivity but also electrical conductivity and is electrically connected to the ends 13a of the four secondary-side coils 13. Likewise, the heat sink 14b possesses not only thermal conductivity but also electrical conductivity and is electrically connected to the ends 13b of the four secondary-side coils 13.

As described above, the heat sinks 14a and 14b are electrically connected in parallel to the four secondary-side coils 13. In the coil unit 10, the voltage stepped down by the secondary-side coils 13 is derived by using the heat sinks 14a and 14b.

The heat sinks 14a and 14b have heat radiation main bodies 14c connected to the ends 13a and 13b of the secondary-side coils 13 and a plurality of protrusions 14d protruding outward from the heat radiation main bodies 14c.

Part of each of the ends 13a and 13b of each secondary-side coil 13 is inserted into the corresponding heat radiation main body 14c and is connected to the heat radiation main body 14c. Specifically, the voltage stepped down by the secondary-side coils 13 is derived via the heat radiation main bodies 14c.

The plurality of protrusions 14d are disposed on the heat radiation main bodies 14c at intervals. Since the heat sinks 14a and 14b having the plurality of protrusions 14d each have a large surface area, it is possible to dissipate the heat transferred from the secondary-side coils 13 into the atmosphere efficiently.

Moreover, the core 11 in which a magnetic flux density vector is produced as a result of the current flowing through the primary-side coil 12 also generates heat in accordance with the amount of iron loss. The heat generated in the core 11 is also dissipated by being transferred to the heat sinks 14a and 14b via the secondary-side coils 13.

As the formation material of the heat sinks 14a and 14b, it is preferable to use a material having higher thermal conductivity and higher electrical conductivity than other metals. For example, as the formation material of the heat sinks 14a and 14b, it is possible to use gold, silver, copper, aluminum, carbon, or the like.

Next, the result of calculation of the temperature of the working coil unit 10 will be described below.

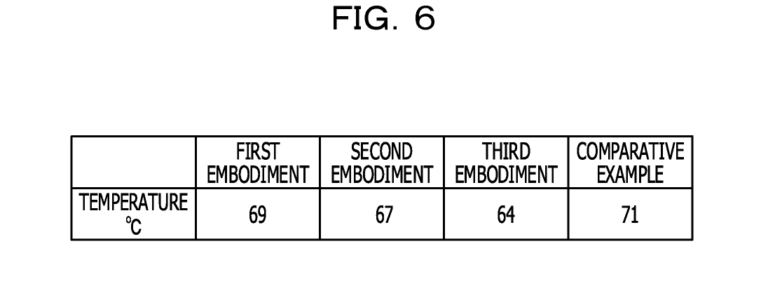

FIG. 6 is a diagram depicting the calculation results of the temperature of the coil unit. In FIG. 6, with the temperature of the working coil unit 10 of the first embodiment, the temperature of a working coil unit of a comparative example is listed.

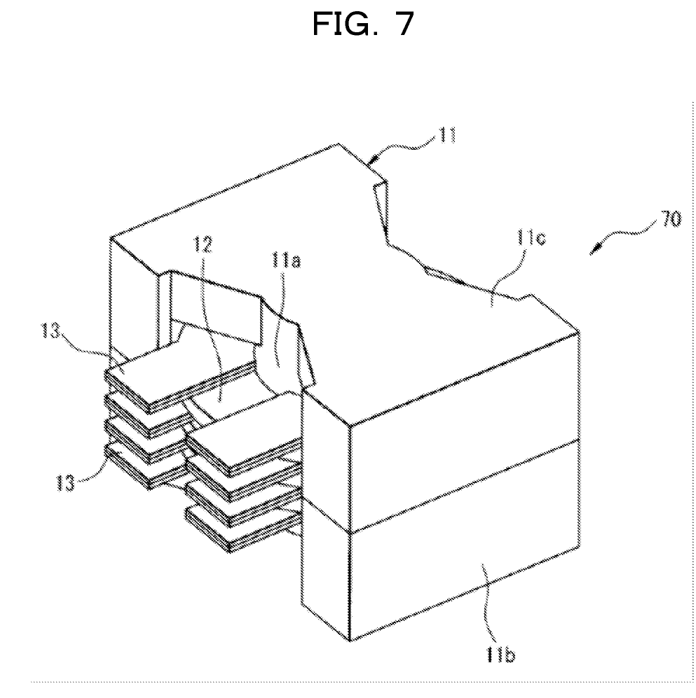

FIG. 7 is a perspective view depicting the coil unit of the comparative example.

A coil unit 70 of the comparative example has the same structure as the coil unit 10 of this embodiment except for the absence of a heat sink.

The temperature of the working coil unit was calculated by electromagnetic analysis using a finite element method. As the formation material of the core 11, Mn-Zn ferrite was used. As the shape of the core 11, the PQ32/20 type was used. The primary-side coil was formed by winding a copper solid wire measuring 0.6 mm in diameter 27 times. The secondary-side coil was formed by stacking two copper plates measuring 0.4 mm in thickness. The input voltage of the primary-side coil was 395 V, the output voltage of the secondary-side coil was 12 V, and the output current was set at 200 A. In FIG. 6, the temperature of the coil unit indicates the temperature of a portion with the highest temperature, specifically, the temperature of the surface of the core.

As depicted in FIG. 6, the calculation results indicating that the temperature of the coil unit 10 of the first embodiment was lower than the temperature of the coil unit of the comparative example, the coil unit without the heat sink, by 2° C. were obtained.

The coil unit 10 of this embodiment described above has high radiation performance, and an increase in temperature is suppressed.

The transformer is used in an operation region in which the magnetic flux density produced in the core changes in response to a change in a magnetic field caused by the current flowing through the primary-side coil. When the temperature of the core increases, this operation region becomes narrow and the transformation function of the transformer is impaired.

In the coil unit 10 which is a transformer, since an increase in the temperature of the core is suppressed by the heat sinks 14a and 14b, the operation region of the transformer is kept from becoming narrow, which suppresses the impairment of the transformation function and thereby makes it possible to obtain a stable operation.

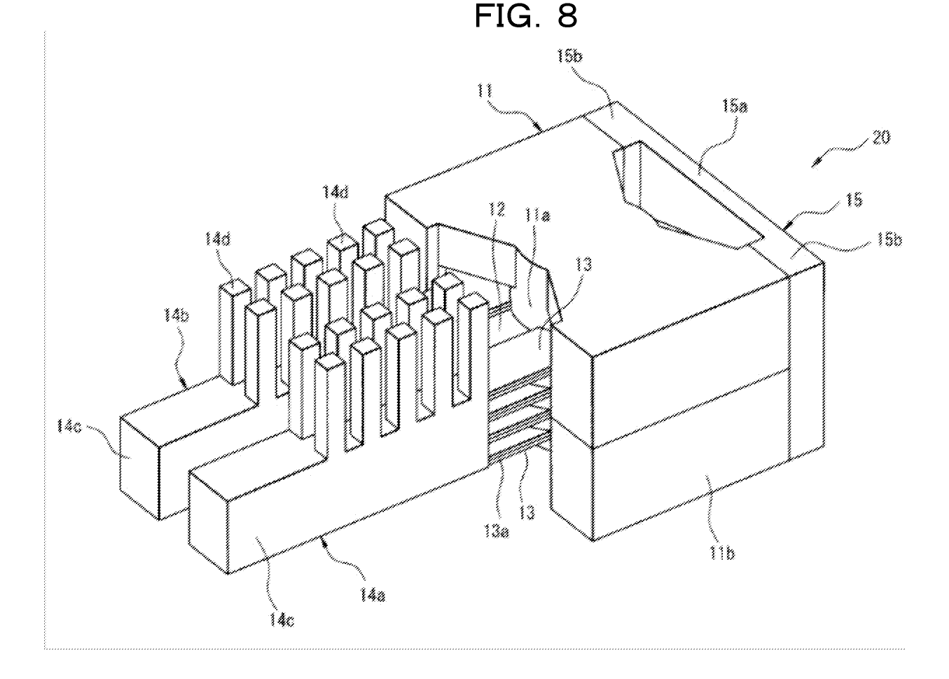

Next, other embodiments of the coil unit described above will be described below with reference to FIGS. 8 to 16. To unexplained points of the other embodiments, the detailed explanations in the first embodiment described above will be appropriately applied. Moreover, the same component elements are identified with the same reference characters.

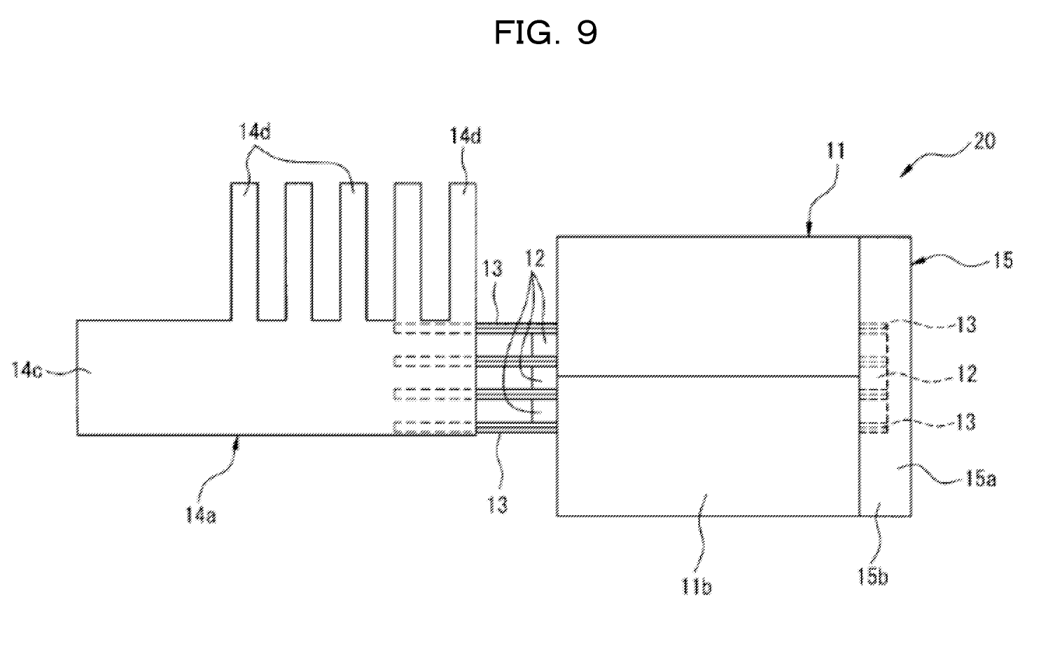

FIG. 8 is a perspective view depicting a second embodiment of the coil unit disclosed in the present specification. FIG. 9 is a side view depicting the second embodiment of the coil unit disclosed in the present specification.

A coil unit 20 of this embodiment has a cover 15 that prevents magnetic flux leakage, the cover 15 covers a portion of a primary-side coil 12 and secondary-side coils 13, the portion exposed to the outside. Specifically, an opening in a core 11 located on the side opposite to heat sinks 14a and 14b is covered with the cover 15. The cover 15 is formed of a magnetic material. The other structures of the coil unit 20 are the same as those of the first embodiment described above.

The cover 15 has a plate-like leakage suppressing main body 15a and a pair of leg sections 15b provided to be hung from the ends of the leakage suppressing main body 15a.

The leakage suppressing main body 15a covers a portion of the primary-side coil 12 and the secondary-side coils 13, the portion being not covered by a pair of outer magnetic legs 11b and a pair of side magnetic sections 11c.

The cover 15 has the leg sections 15b connected to the outer magnetic legs 11b and forms a magnetic circuit with the core 11.

In the past, a core of a coil unit such as a transformer has had an opening from which the coil is exposed to the outside in order to draw the end of the coil to the outside and dissipate the generated heat.

On the other hand, there is a possibility that a magnetic flux density vector guided by the working coil leaks to the outside through the opening and produces magnetic interference in surrounding electronic devices or the leaked magnetic flux density vector sets up an eddy current in an outside electric conductor and causes power loss.

Since the coil unit 20 of this embodiment has excellent radiation performance due to the heat sinks 14a and 14b, even when the opening is covered with the cover 15, it is possible to suppress an increase in temperature.

The magnetic flux density vector that is guided by the primary-side coil 12 through which the current flows is formed by a magnetic material and is produced in such a way as to pass through the cover 15 having higher magnetic permeability than the atmosphere.

In the coil unit 20 in which the opening is covered with the cover 15, since the magnetic flux density vector produced by the working coil returns to the core 11 through the cover 15 which is a magnetic material, it is possible to reduce the amount of the magnetic flux density vector that leaks to the outside through the opening. Moreover, with the coil unit 20, since the leakage of the magnetic flux density vector to the outside is reduced, it is possible to suppress the occurrence of an eddy current in the outside.

From the viewpoint of suppressing the occurrence of an eddy current in the cover 15, it is preferable to form the cover 15 by using a magnetic material having electrical insulating properties, such as ferrite.

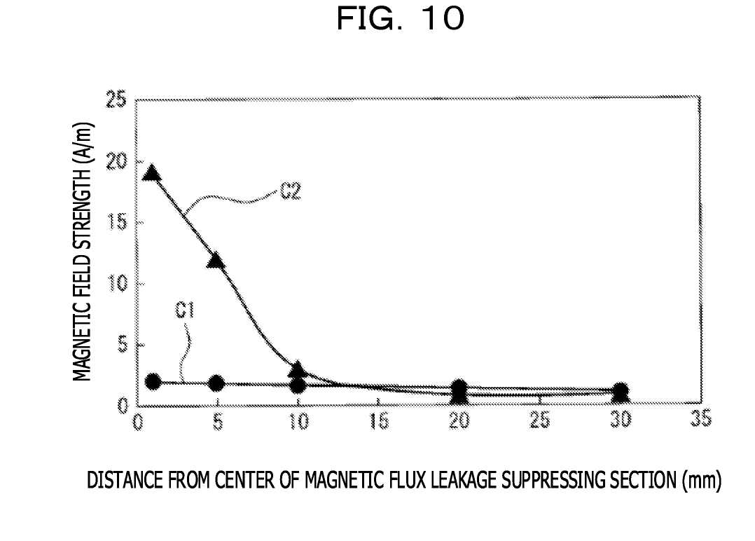

Next, the result of calculation of the strength of a magnetic field that leaks to the outside from the working coil unit 20 will be described below with reference to FIG. 10.

FIG. 10 is a diagram of the relationship between the magnetic field strength and the distance from the center of the cover.

In FIG. 10, a curve C1 indicates the strength of a magnetic field that leaks from the coil unit 20, and a curve C2 indicates the strength of a magnetic field that leaks from the coil unit of the first embodiment, the coil unit provided with no magnetic flux leakage suppressing plate.

The horizontal axis of FIG. 10 indicates the distance from the center of the cover in the coil unit 20. The horizontal axis for the curve C2 indicates the distance from the same position as the center position of the cover in the coil unit 20.

The strength of a magnetic field that leaks from the working coil unit was calculated by electromagnetic analysis using a finite element method. As the formation material of the core 11, Mn—Zn ferrite was used. As the shape of the core 11, the PQ32/20 type was used. The primary-side coil was formed by winding a copper solid wire measuring 0.6 mm in diameter 27 times. The secondary-side coil was formed by stacking two copper plates measuring 0.4 mm in thickness. The input voltage of the primary-side coil was 395 V, the output voltage of the secondary-side coil was 12 V, and the output current was set at 200 A.

As depicted in FIG. 10, as compared to the curve C2, the curve C1 indicates that leakage of the magnetic flux density observed when the distance is within 10 mm is greatly reduced.

Next, the result of calculation of the temperature of the working coil unit 20 will be described below.

FIG. 6 is the diagram depicting the calculation result of the temperature of the coil unit 20 of the second embodiment.

The calculation of the temperature of the coil unit 20 was performed under the same conditions as the coil unit of the first embodiment described above except for the presence of the cover 15.

As depicted in FIG. 6, the calculation results indicating that the temperature of the coil unit 20 of the second embodiment is lower than the temperature of the coil unit of the comparative example, the coil unit without the heat sink, by 4° C. and is lower than the coil unit of the first embodiment, the coil unit without the magnetic flux leakage suppressing plate, by 2° C. were obtained.

The reason why the temperature of the coil unit 20 of this embodiment is lower than the temperature of the coil unit of the first embodiment is considered as follows: since the cover 15 functions as part of the core 11, the iron loss of the core 11 is reduced.

With the above-described coil unit 20 of this embodiment, it is possible to suppress an increase in the temperature of the coil unit 20 and reduce leakage of magnetic flux density.

Moreover, with the coil unit 20, since the cover 15 functions as part of the core 11, the volume of the core 11 has substantially increased, and, since the inductance of the coil unit 20 increases, electric energy that is able to be accumulated increases. Therefore, with the coil unit 20, as compared to the coil unit without the cover, it is possible to reduce the resistance loss of the coil while maintaining equal performance by reducing the number of times of winding of the coil.

Next, a third embodiment of the coil unit disclosed in the present specification will be described below with reference to the drawings.

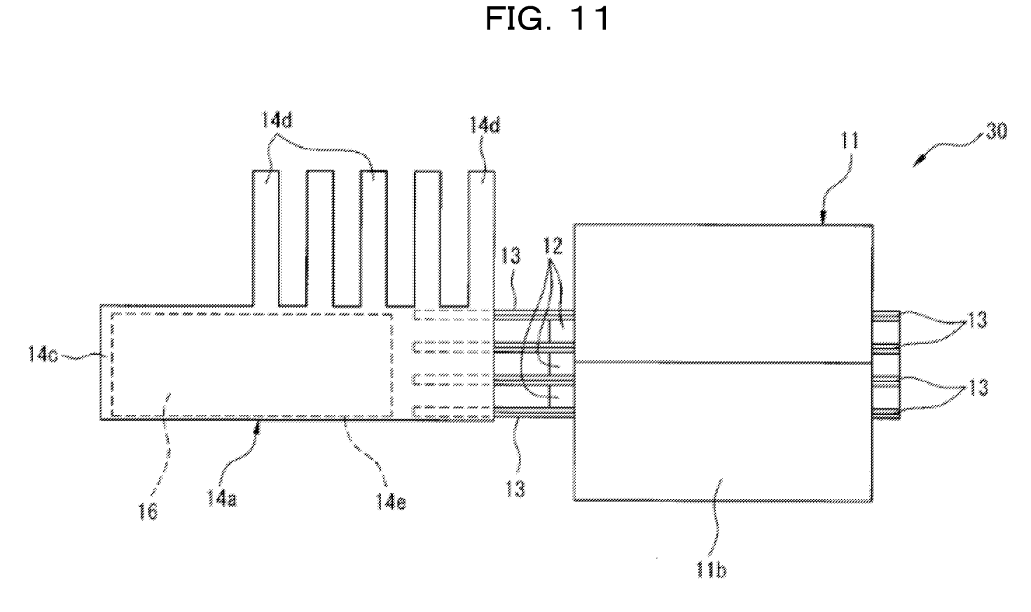

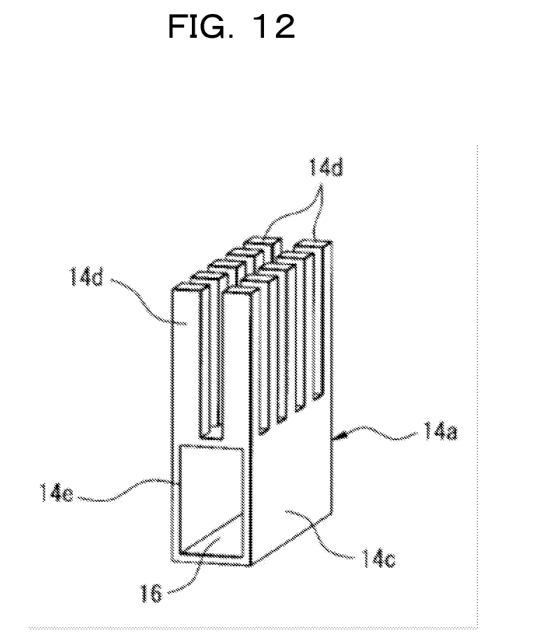

FIG. 11 is a side view depicting the third embodiment of the coil unit disclosed in the present specification. FIG. 12 is a sectional view of a heat sink of the coil unit.

Heat sinks 14a and 14b of a coil unit 30 of this embodiment each have a heat pipe 16. The other structures of the coil unit 30 are the same as those of the first embodiment described above.

A heat radiation main body 14c of each of the heat sinks 14a and 14b has a hollow space 14e, and the heat pipe 16 is formed in this hollow space 14e. The hollow space 14e is formed in such a way as to extend from a position below the protrusions 14d in a direction opposite to the secondary-side coils 13. In the hollow space 14e, a differential fluid (not depicted) and a wick (not depicted) which is a capillary structure impregnated with the differential fluid are encapsulated.

The differential fluid in the hollow space 14e promotes heat dissipation by the heat sinks 14a and 14b by repeating a cycle in which the differential fluid evaporates by the heat transferred from the secondary-side coils 13, moves to a low-temperature portion in the hollow space 14e, and changes into liquid as a result of being cooled and condensed.

In the example depicted in FIG. 12, the hollow space 14e has a rectangular cross-sectional shape, but the shape of the hollow space 14e is not limited to a particular shape. The hollow space 14e may have a circular cross-sectional shape, for example.

As the differential fluid encapsulated in the hollow space 14e, it is possible to use, for example, distilled water, a fluorinated inert liquid, or the like.

Next, the result of calculation of the temperature of the working coil unit 30 will be described below.

FIG. 6 is the diagram depicting the calculation result of the temperature of the coil unit 30 of the third embodiment.

The calculation of the temperature of the coil unit 30 was performed under the same conditions as the coil unit of the first embodiment described above except for the presence of the heat pipe 16. As the differential fluid of the heat pipe 16, distilled water was used.

As depicted in FIG. 6, the calculation results indicating that the temperature of the coil unit 30 of the third embodiment is lower than the coil unit of the comparative example, the coil unit without the heat sink and the heat pipe, by 7° C. and is lower than the coil unit of the first embodiment, the coil unit without the heat pipe, by 5° C. were obtained.

With the above-described coil unit 30 of this embodiment, since the heat sinks 14a and 14b have higher radiation performance because the heat sinks 14a and 14b each have the heat pipe 16, an increase in temperature is further suppressed.

Next, a fourth embodiment of the coil unit disclosed in the present specification will be described below with reference to the drawings.

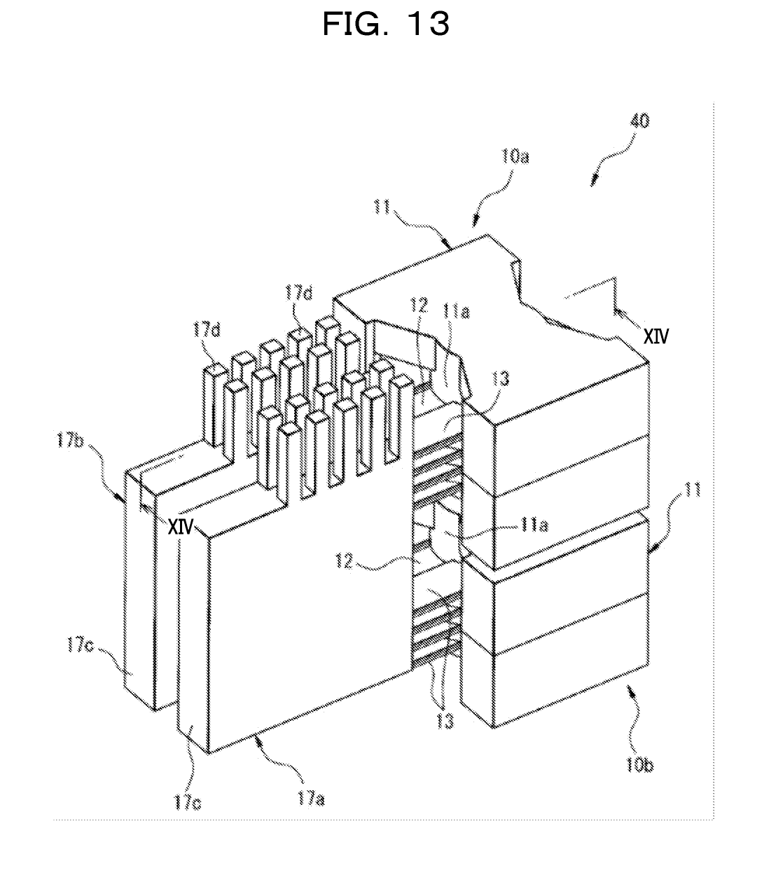

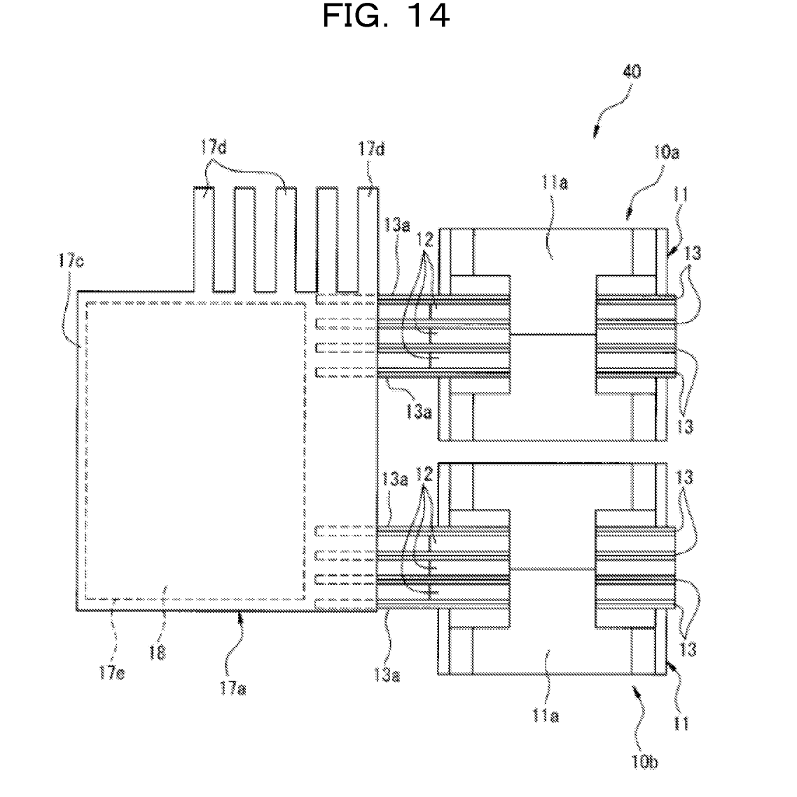

FIG. 13 is a perspective view depicting the fourth embodiment of the coil unit disclosed in the present specification. FIG. 14 is a sectional view taken on the line XIV-XIV of FIG. 13.

A coil unit 40 of this embodiment includes a first coil section 10a and a second coil section 10b and heat sinks 17a and 17b shared by the first coil section 10a and the second coil section 10b.

The first coil section 10a and the second coil section 10b have the same structure as the above-described coil unit of the first embodiment from which the heat sinks are removed.

The first coil section 10a and the second coil section 10b are disposed vertically with a space left between the first coil section 10a and the second coil section 10b in such a way that the outlines of the cores 11 match each other.

The heat sinks 17a and 17b possess not only thermal conductivity but also electrical conductivity and each have a heat radiation main body 17c connected to ends 13a and 13b of secondary-side coils 13 in the first coil section 10a and the second coil section 10b and a plurality of protrusions 17d protruding outward from each heat radiation main body 17c.

The heat radiation main body 17c of the heat sink 17a is electrically connected to the ends 13a of the four secondary-side coils 13 in the first coil section 10a and to the ends 13a of the four secondary-side coils 13 in the second coil section 10b. Likewise, the heat radiation main body 17c of the heat sink 17b has an electrical conducting property and is electrically connected to the ends 13b of the four secondary-side coils 13 in the first coil section 10a and to the ends 13b of the four secondary-side coils 13 in the second coil section 10b.

In the coil unit 40, the voltage stepped down by the secondary-side coils 13 of the first coil section 10a and the second coil section 10b is derived by using the heat sinks 17a and 17b. Moreover, the heat sinks 17a and 17b each have a heat pipe 18.

The heat radiation main body 17c of each of the heat sinks 17a and 17b has a hollow space 17e, and the heat pipe 18 is formed in the hollow space 17e. The hollow space 17e is formed in such a way as to extend from a position below the protrusions 17d in a direction opposite to the secondary-side coils 13. In the hollow space 17e, a differential fluid (not depicted) and a wick (not depicted) which is a capillary structure impregnated with the differential fluid are encapsulated.

The differential fluid in the hollow space 17e promotes heat dissipation by the heat sinks 17a and 17b by repeating a cycle in which the differential fluid evaporates by the heat transferred from the secondary-side coils 13, moves to a low-temperature portion in the hollow space 17e, and changes into liquid as a result of being cooled and condensed.

With the above-described coil unit 40 of this embodiment, it is possible to dissipate the heat transferred from the secondary-side coils 13 of the first coil section 10a and the second coil section 10b by using the heat sinks 17a and 17b shared by the first coil section 10a and the second coil section 10b. Therefore, as compared to a case where individual heat sinks are provided in the first coil section 10a and the second coil section 10b, it is possible to reduce the number of parts.

Next, a fifth embodiment of the coil unit disclosed in the present specification will be described below with reference to the drawings.

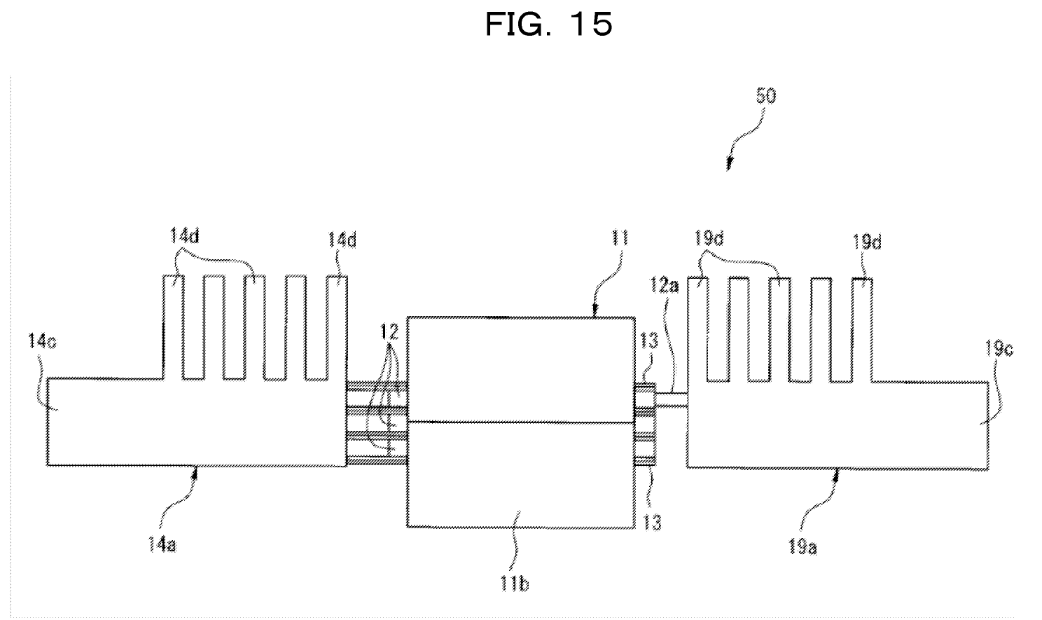

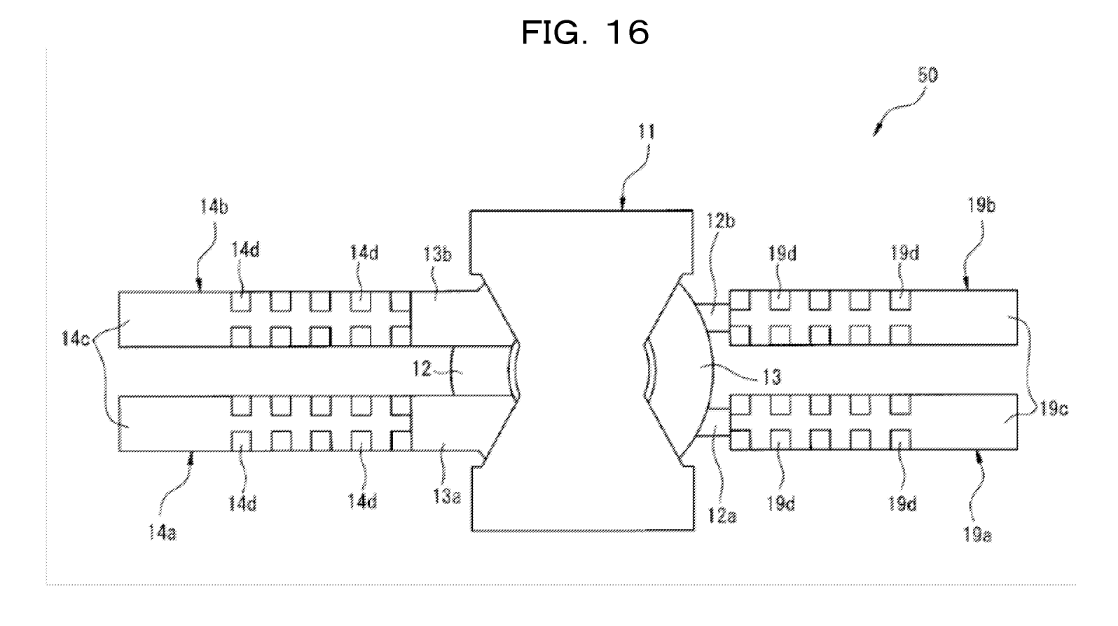

FIG. 15 is a side view depicting the fifth embodiment of the coil unit disclosed in the present specification. FIG. 16 is a plan view depicting the fifth embodiment of the coil unit disclosed in the present specification.

A coil unit 50 of this embodiment suppresses an increase in the temperature of the coil unit 50 by connecting heat sinks 19a and 19b which are separate bodies also to the primary-side coil 12 and transferring the heat generated in the primary-side coil 12 to the heat sinks 19a and 19b and dissipating the heat from the heat sinks 19a and 19b.

The other structures of the coil unit 50 are the same as those of the first embodiment described above.

The heat sinks 19a and 19b possess not only thermal conductivity but also electrical conductivity and have heat radiation main bodies 19c connected to ends 12a and 12b of the primary-side coil 12 and a plurality of protrusions 19d protruding outward from the heat radiation main bodies 19c.

A voltage that is applied to the primary-side coil 12 of the coil unit 50 is supplied via the heat sinks 19a and 19b.

The plurality of protrusions 19d are disposed on the heat radiation main bodies 19c at intervals. Since the heat sinks 19a and 19b having the plurality of protrusions 19d each have a large surface area, it is possible to dissipate the heat transferred from the primary-side coil 12 into the atmosphere efficiently.

Since the above-described coil unit 50 of this embodiment includes the heat sinks 19a and 19b that dissipate the heat transferred from the primary-side coil 12, the coil unit 50 has higher radiation performance, and an increase in temperature is further suppressed.

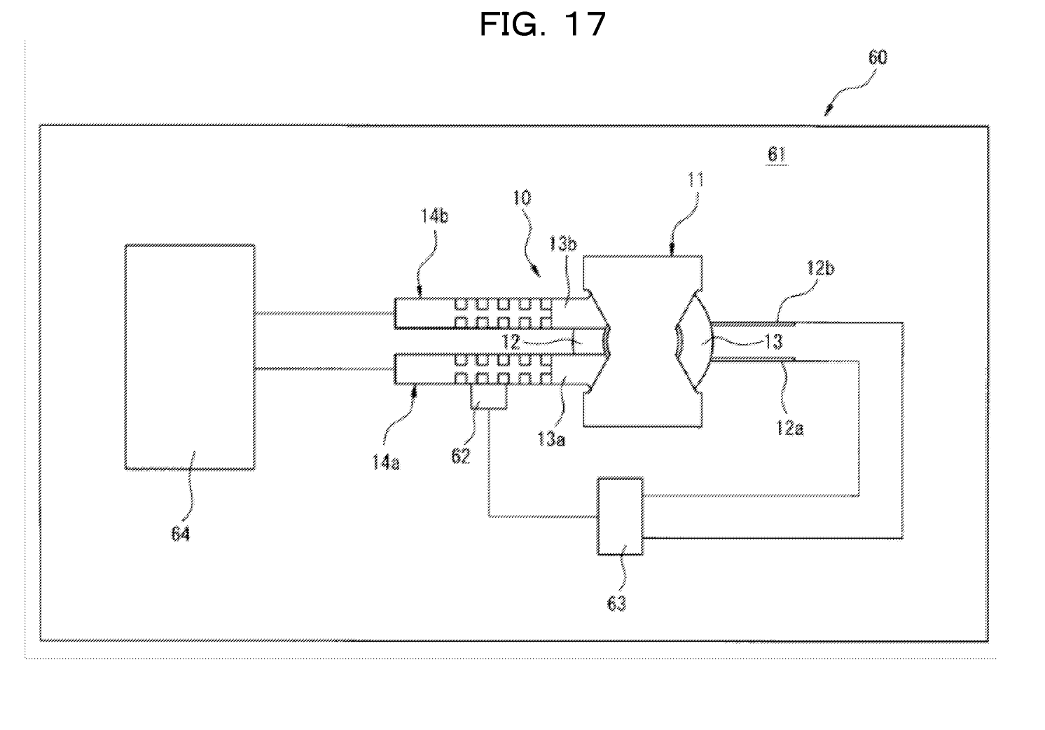

Next, an electronic apparatus provided with the above-described coil unit will be described below with reference to FIG. 17.

FIG. 17 is a diagram depicting an electronic apparatus provided with the coil unit disclosed in the present specification.

An electronic apparatus 60 includes a circuit substrate 61, the coil unit 10 of the first embodiment described above, a temperature sensor 62 that measures the temperature of the heat sink 14a of the coil unit 10, and a control circuit 63 that controls power to be supplied to the primary-side coil 12 of the coil unit 10 based on the temperature measured by the temperature sensor 62. The primary-side coil 12 has the ends 12a and 12b from which the power supplied from the control circuit 63 is input.

Moreover, the electronic apparatus 60 includes a load circuit 64 to which the power output from the secondary-side coils 13 is supplied via the heat sinks 14a and 14b.

The coil unit 10, the temperature sensor 62, the control circuit 63, and the load circuit 64 are disposed on the same circuit substrate 61.

To the control circuit 63, power is supplied from an unillustrated external power source. Based on the temperature of the heat sink 14a, the temperature input from the temperature sensor 62, the control circuit 63 controls a current that is supplied to the primary-side coil 12 in a state in which a voltage that is applied to the primary-side coil 12 is stabilized.

For example, if the temperature of the working coil unit 10 rises and exceeds a predetermined threshold value, the control circuit 63 performs control in such a way as to reduce the current that is supplied to the primary-side coil 12 in a state in which the voltage that is applied to the primary-side coil 12 is stabilized. As a result of the current to be output being reduced in a state in which the voltage that is output from the secondary-side coils 13 is stabilized, since the amount of heat generation of the secondary-side coils 13 is reduced, the temperature of the heat sink 14a drops.

With the electronic apparatus 60 described above, it is possible to control the coil unit 10 by suppressing an increase in temperature in such a way that the temperature of the heat sink 14a does not exceed a predetermined threshold value. The coil unit 10 provided with the heat sinks 14a and 14b originally has high radiation performance and an increase in temperature is suppressed; in the electronic apparatus 60, by controlling the power that is supplied to such a coil unit 10, it is possible to suppress an increase in the temperature of the coil unit 10 as intended more effectively.

The coil unit, the electronic apparatus, and the method for controlling the coil unit of the embodiments described above may be changed as appropriate without departing from the spirit of the embodiments. Moreover, a component element of one embodiment may be applied to the other embodiments as appropriate.

For example, although the coil unit of each embodiment described above is a so-called PQ-type transformer, the coil unit may be a transformer with an opening, for example, the transformer of the other type such as an EE-type or an EI-type transformer.

Moreover, the coil unit of each embodiment described above is a transformer, but the coil unit may be an inductor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transformer comprising:
a core;
a coil wound around the core; and
a heat sink coupled to the coil.

2. The transformer according to claim 1, wherein
the heat sink has a heat pipe.

3. The transformer according to claim 1, wherein
the heat sink possesses electrical conductivity and is coupled to an end of the coil.

4. The transformer according to claims 1, further comprising:
a cover that is formed of a magnetic material and covers a portion of the coil, the portion being exposed to an outside.

5. The transformer according to claim 4, wherein
the core includes
an inner magnetic leg around which the coil is wound,
a pair of outer magnetic legs disposed in such a way as to sandwich the inner magnetic leg around which the coil is wound, and
a side magnetic substance that couples the inner magnetic leg and the pair of outer magnetic legs in such a way as to form a magnetic circuit, and
the cover covers a portion of the coil, the portion being not covered by the pair of outer magnetic legs and the side magnetic substance.

6. The transformer according to claim 1, wherein
the heat sink includes
a heat radiation main body coupled to the coil, and
a protrusion protruding from the heat radiation main body.

7. The transformer according to claim 1, wherein
the coil includes a primary-side coil and a secondary-side coil,
the primary-side coil and the secondary-side coil are wound around the core, and
the heat sink is coupled to an end of the secondary-side coil.

8. An electronic apparatus comprising:
a transformer that includes
a core,
a coil wound around the core, and
a heat sink coupled to the coil;
a temperature sensor that measures a temperature of the heat sink; and
a controller that controls power to be supplied to the coil based on the temperature measured by the temperature sensor.

9. A method for controlling a transformer, the method comprising:
measuring a temperature of a heat sink of a transformer that includes
a core,
a coil wound around the core, and
the heat sink coupled to the coil; and
controlling power to be supplied to the coil based on the measured temperature.
